(19) United States
(12) Patent Application Publication
(10) Pub. No.: US 2010/0075009 A1
(43) Pub. Date: Mar. 25, 2010

(54) FROZEN JUICE PREPARATION AND PRESENTATION

(75) Inventor: Derek Stem, Stouffville (CA)

Correspondence Address: DENNISON ASSOCIATES, 133 RICHMOND STREET WEST, SUITE 301, TORONTO, ON, M5H 2L7, CA

(73) Assignee: 1645127 Ontario Inc., Stouffville (CA)

(21) Appl. No.: 12/238,421

(22) Filed: Sep. 25, 2008

(51) Int. Cl. A23P 1/00; A23L 3/36; A47J 43/00; B67D 5/60

(52) U.S. Cl. 426/518; 426/524; 426/519; 99/537; 222/145.1

(57) ABSTRACT

The present invention is directed to a method and apparatus for the rapid preparation of a drink from a frozen liquid which contains high concentrations of nutrients. The method involves increasing the surface area of the frozen liquid and adding the increased area of frozen juice to a suitable amount of additional liquid and allowing it to mix. The apparatus for preparing a drink from the frozen liquid includes a means for increasing the surface area of the frozen liquid by breaking the frozen liquid into a plurality of pieces, and a means for dispensing the plurality of pieces of the frozen liquid into a serving container. Preferably, the apparatus also includes a means for passing an additional liquid through the means for increasing the surface area of the frozen liquid and the means for dispensing the frozen liquid to wash out any residual frozen liquid in the apparatus into the serving container.

### FIELD OF THE INVENTION

The present invention relates to a method and apparatus for the rapid preparation of frozen fruit and vegetable juices into a liquid form and in particular to a method and apparatus to increase the surface area of the frozen products during preparation.

### BACKGROUND OF THE INVENTION

The consumption of natural juices prepared in a manner to retain maximum nutritional content of the juice has become increasing popular. A common such type of juice is wheatgrass juice which is produced from the first state of grain. The grass is processed to extract the juice which is high in nutrient contents including vitamins, minerals and chlorophyll. Such juices as wheatgrass juice begin to loss the vital vitamins and nutrients within a short time of being juiced. In order to preserve such nutrients, the juice is generally frozen in handy sized cubes which are either thawed and consumed straight or are placed in a quantity of water and allowed to thaw. One problem with this is that it takes time for the frozen juice to thaw which does not make it amenable to commercial service applications.

There thus remains a need for a method of presentation of the frozen juices which allow for their rapid reconstitution while preserving the nutrient value of the reconstituted juice.

### SUMMARY OF THE INVENTION

The present invention is directed to a method of rapid preparation of drinks from frozen liquids which contain high concentrations of nutrients. The method involves increasing the surface area of the frozen juice and adding the increased area of frozen juice to a suitable amount of liquid and allowing it to mix.

In an aspect of the invention, the method comprises shaving or crushing the frozen liquid to increase the exposed surface area of the frozen liquid and adding sufficient water or other liquid to the shaved or crushed frozen liquid to accelerate the melting of the frozen liquid.

In another aspect of the invention the water or other liquid used to accelerate the melting of the frozen liquid is passed through the apparatus used for the shaving or crushing to wash out any of the frozen liquid retained in the apparatus during the shaving or crushing step.

In yet another aspect of the invention, there is provided an apparatus for preparing a drink from a frozen liquid, the apparatus comprising a means for increasing the surface area of the frozen liquid by breaking the frozen liquid into a plurality of pieces, and a means for dispensing the plurality of pieces of the frozen liquid into a serving container.

In a further aspect of the invention, the apparatus also includes a means for passing a liquid through the means for increasing the surface area of the frozen liquid and the means for dispensing the frozen liquid to wash out any residual frozen liquid in the apparatus into the serving container.

### BRIEF DESCRIPTION OF THE DRAWINGS

Preferred embodiments of the invention are illustrated in the attached drawings in which:

FIG. 1 is a perspective view in outline of a first embodiment of an apparatus for use in the present invention; and

FIG. 2 is a perspective view in outline of a second embodiment of an apparatus for use in the present invention.

### DETAILED DESCRIPTION OF THE PREFERRED EMBODIMENTS

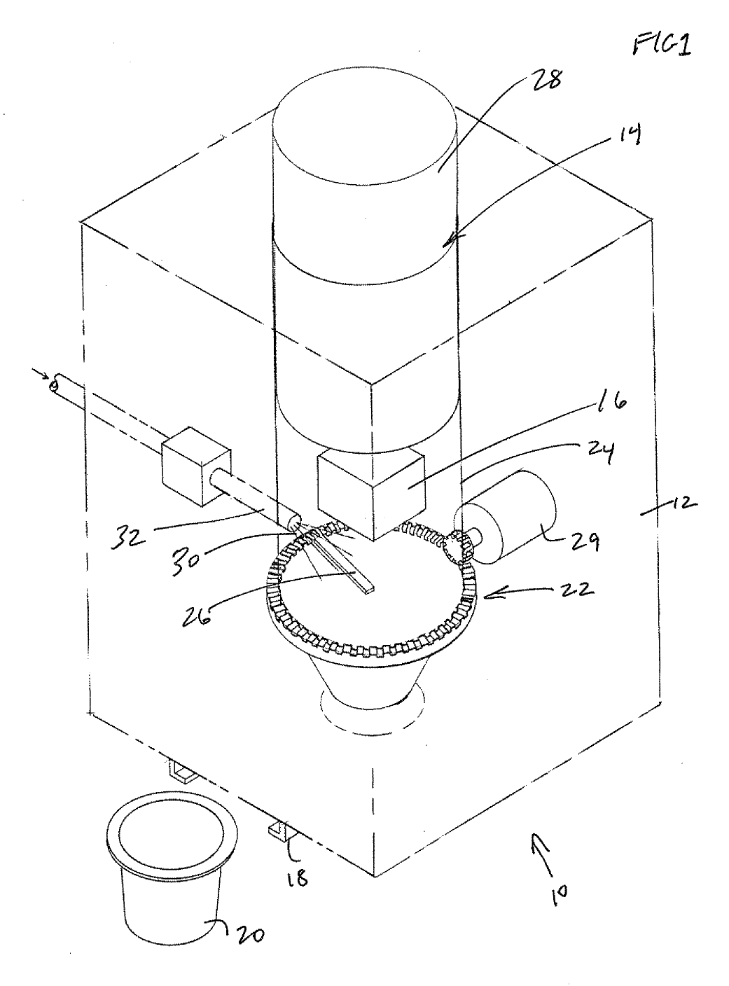

The present invention is directed to a method and apparatus for the rapid reconstitution of frozen liquids which contain high concentrations of nutrients. A first embodiment of the apparatus of the present invention is illustrated in FIG. 1 generally indicated by the numeral 10. Apparatus 10 has a housing 12 holding all of the components of the apparatus 10. At the top of the apparatus 10 is an inlet 14 to allow the frozen liquid 16 to be placed into the apparatus 10. Apparatus 10 at the lower end is provided with a holder 18 to hold a serving container 20 for the reconstituted liquid.

As shown in FIG. 1, the inlet 14 of the apparatus 10 opens to a means for increasing the surface area of the frozen liquid 16 by breaking the frozen liquid into a plurality of pieces. In the apparatus shown in FIG. 1, this means is an ice shaver 22, although as described below, other means are usable. Ice shaver 22 has a cylinder 24 sized to accept the frozen liquid 16 and a blade 26 to shave the frozen liquid 16 into a plurality of smaller pieces, thereby increasing the surface area of the frozen liquid to rapidly reconstitute it.

In order to force the frozen liquid 16 against the blade 26, the apparatus 10 is provided with a means to push the frozen liquid 16 down the cylinder 24 and against the blade 26. The means to push the frozen liquid 16 could be a plunger 28 of the same dimension as the interior of the cylinder. Plunger 28 could be either manually operated or could be automatically operated under control of the apparatus. In order to shave the frozen liquid into a plurality of pieces, the frozen liquid is rapidly passed over the blade 26. This can be accomplished either by rotating the blade 26 by means of a suitable motor 29 or by rotating the plunger 28 against a fixed blade 26

After the frozen liquid shavings exit the blade 26, they are dispensed into the serving container 20 at the bottom of the apparatus. In order to ensure all of the shavings are dispensed and the drink from the frozen liquid 16 is rapidly prepared, a liquid 30 is passed through the apparatus. As shown in the figures, the liquid 30 is automatically dispensed by a suitable means such as the spray head 32. Spray head 32 automatically dispenses the proper amount of the liquid 30 into the cylinder 24 and this liquid 30, then flows through the cylinder 24 and blade 26 washing any residual pieces of frozen liquid in the apparatus into the serving container 20.

In operation, a user places the frozen liquid 16 into the cylinder 24 through the inlet 14 and then starts the apparatus 10. The plunger 28 pushes the frozen liquid 16 against the blade 26 which shaves the frozen liquid 16 into a plurality of ice shavings which are dispensed into the serving container 20. The liquid 30 is then passed through the apparatus 10 washing any residual pieces of the frozen liquid 16 into the serving container 20. The juice is then given to the purchaser.

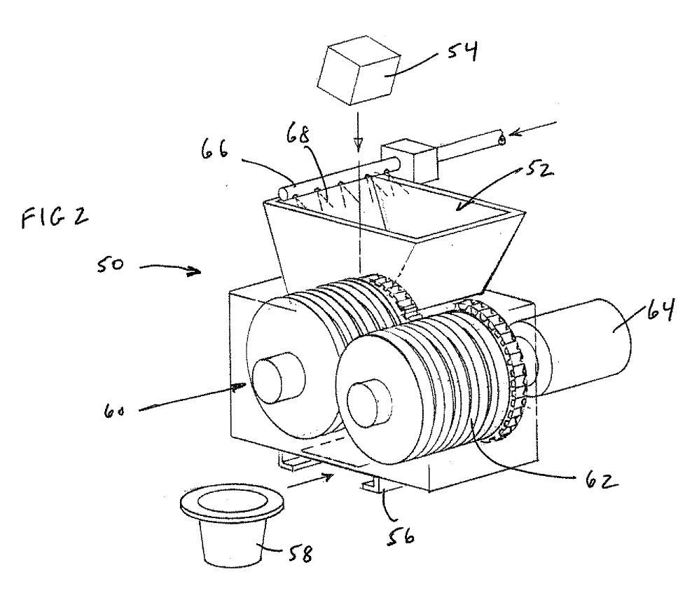

A second embodiment of an apparatus for the present invention is illustrated in FIG. 2 generally indicated by the numeral 50. Apparatus 50 has an inlet 52 for the frozen liquid 54 and a holder 56 for a serving container 58. In the apparatus 50 of this embodiment, the means for increasing the surface area of the frozen liquid by breaking the frozen liquid into a plurality of pieces is an ice crusher 60 having opposed cylinders 62 driven by motor 64 which break the frozen liquid into the plurality of pieces. Similar to the first embodiment, the apparatus 50 also includes a spray head 66 to pass the liquid 68 through the apparatus.

The apparatus of the present invention will be constructed of suitable materials, mostly plastics and metal. Preferably, the apparatus of the present invention will use stainless steel and plastic components which allow for ease of operation and high throughput. For example, the blades used to shave the frozen liquid are preferably stainless steel. In order to not have the frozen liquid melt too quickly while being processed in the apparatus of the present invention, it is preferred that most of the components of the apparatus that are in contact with the frozen liquid are plastic to reduce thermal transfer. Thus, preferably the cylinder and plunger are constructed of a plastic material.

The method and apparatus of the present invention provides for rapid preparation of frozen fruit and vegetable juices into a liquid drink form. The frozen fruit and vegetable juice may be any of the commonly utilized such juices, particularly those high in nutrient value and where the juice begins to lose the vital vitamins and nutrients within a short time of being juiced. Examples of such juices include those derived from Acai, Aronia, Camu-Camu, Gogi, Noni, Cyanobacteria, Mangosteen, Pomegranate, Wheatgrass, Wheat grass, Wolfberry as well as blends that contain one or more of these ingredients. Other types of juices would be well known to those of skill in the art.

By rapidly preparing the drink from the frozen fruit and vegetable juice, the nutrient value of the juice is retained and the serving of such juices is amenable to high throughput locations such as juice bars and coffee shops. The purchaser of the juice may immediately consume the beverage without having to wait for a large piece of frozen liquid to thaw. By breaking the frozen liquid into a plurality of small pieces, the exposed surface area of the frozen liquid is significantly increased such that the thawing and preparation of the frozen liquid is almost instantaneous once the additional liquid is added.

As such juices are generally served in small serving of 10 oz or less, the apparatus of the present invention is sized to accommodate and process small volumes of frozen liquid, generally on the order of 1 to 2 oz. Typically the apparatus would utilize up to 5 times the volume of additional liquid based upon the volume of the frozen liquid. Thus for a 1 oz serving of frozen liquid, preferably 3 to 5 oz of additional liquid would be utilized.

The additional liquid may be any of the commonly employed liquids, including water, other juices etc. Preferably, the additional liquid would be water or apple juice. By passing the additional liquid through the apparatus to wash out any remaining pieces of the frozen liquid, the same apparatus may be utilized with different frozen liquids with minimal cross contamination of the reconstituted juice.

Although various preferred embodiments of the present invention have been described herein in detail, it will be appreciated by those skilled in the art that variations may be made thereto without departing from the spirit of the invention or the scope of the appended claims.

We claim:

1. A method of rapid preparation of a drink from frozen liquids which contain high concentrations of nutrients, the method comprising processing the frozen liquid to increase the surface area of the frozen liquid, adding a suitable amount of additional liquid to the increased area of frozen liquid and allowing it to mix.

2. The method according to claim 1 wherein the processing of the frozen liquid comprises shaving or crushing the frozen liquid to increase the exposed surface area of the frozen liquid and adding sufficient water or other liquid to the shaved or shredded frozen liquid to prepare the drink.

3. The method according to claim 2 wherein the water or other liquid is passed through the apparatus used for the shaving or crushing to wash out any of the frozen liquid retained in the apparatus during the shaving or crushing step.

4. An apparatus for preparing a drink from a frozen liquid, the apparatus comprising a means for increasing the surface area of the frozen liquid by breaking the frozen liquid into a plurality of pieces, and a means for dispensing the plurality of pieces of the frozen liquid into a serving container.

5. An apparatus according to claim 4 wherein the apparatus also includes a means for passing an additional liquid through the means for increasing the surface area of the frozen liquid and the means for dispensing the frozen liquid to wash out any residual frozen liquid in the apparatus into the serving container.

6. An apparatus according to claim 5 wherein the means for increasing the surface area of the frozen liquid is an ice shaver.

7. An apparatus according to claim 6 wherein means for passing an additional liquid through the apparatus includes a spray head for directing the additional fluid through the apparatus.
